(19) United States
(12) Patent Application Publication
(10) Pub. No.: US 2021/0241717 A1
(43) Pub. Date: Aug. 5, 2021

(54) IMAGE DISPLAY SYSTEM AND IMAGE DISPLAY METHOD

(71) Applicant: Sharp NEC Display Solutions, Ltd., Tokyo (JP)

(72) Inventor: Katsuyuki MATSUI, Tokyo (JP)

(21) Appl. No.: 17/236,749

(22) Filed: Apr. 21, 2021

Related U.S. Application Data
(63) Continuation of application No. PCT/JP2018/041470, filed on Nov. 8, 2018.

(51) Int. Cl. G09G 5/02; G06F 3/14

(52) U.S. Cl. CPC G09G 5/02; G06F 3/1446

(57) ABSTRACT

According to the present invention, there is provided an image display system that comprises a composite display screen by adjacently arranging display screens of a plurality of display devices using predetermined setting information, in which each of the display devices includes a color adjusting unit that performs adjustment of colors of each corner area in each of the display screens, and the image display system includes a screen display control unit configured to output environment correction data for adjusting color difference between the corresponding display screens to the color adjusting units.

### TECHNICAL FIELD

The present invention relates to an image display system such as a video wall system that displays an image on a screen having a large area (large screen) and an image display method.

### BACKGROUND ART

In recent years, video display devices having a large screen exceeding 100 inches (for example, display devices using a liquid crystal panel) have been requested mainly in processing management of factories, operation management of traffic, advertisement of products, and the like. For this reason, generally, a large screen is realized, for example, in a video wall configuration (a video wall system, which is one example of a multiple-display configuration) by disposing a plurality of predetermined display devices of inches likes tiles laid on a plane, in other words, the display devices are aligned to be adjacent to each other.

Then, division display in which an image displayed on the entire screen is divided in correspondence with the number of display screens of the aligned display devices, and the divided images are each displayed on the display screens of the display devices is performed.

In the case of a video wall system performing this division display, there are cases in which subtle differences of chromaticity (color differences) occur between display screens of display devices due to individual differences of display characteristics of the display devices that are constituent elements of the video wall system.

Due to differences of chromaticity between display screens of the display devices, in a case in which a white image is displayed on the entire large screen, a defect of a color shift is easily visible at a boundary part at which display screens of display devices adjacent to each other are in contact with each other (an end part area near a contacting side (hereinafter, simply referred to as a side area) and an end part area near a contacting corner (hereinafter, simply referred to as a corner area)).

In order to reduce a color shift that is visible as the defect described above, a technique of imaging a display screen at the time of production of each display device using an imaging device, correcting a measured color unevenness, and reducing a visible color shift by matching display characteristics of display screens of display devices is generally used.

As one method for uniformly adjusting display colors of pixels within display screens of individual display devices, there is a method of performing color unevenness adjustment at the time of producing the display devices described above (for example, see Non Patent Literature 1).

In addition, as one method for uniformly adjusting display colors (of each of color components RGB) of pixels within display screens of individual display devices, there is a method of a user performing color unevenness adjustment after shipment using a color unevenness readjustment function (uniformity adjustment function) of display devices (for example, see Non Patent Literature 2).

Furthermore, as one method of uniformly adjusting display colors of pixels within display screens of individual display devices, there is a method of performing switching between gradation correction characteristics of pixels included in an area for each predetermined area within display screens of individual display devices and preventing gradation inversion according to a viewing angle (for example, see Patent Literature 1).

### CITATION LIST

### Patent Literature

### [Patent Literature 1]

Japanese Unexamined Patent Application, First Publication No. 2010-14909

### Non Patent Literature

### [Non Patent Literature 1]

NEC Display Solutions, Unevenness Correction (https://www.nec-display.com/global/jp/technology/tec_mnt_unf.html, accessed on Oct. 19, 2018).

### [Non Patent Literature 2]

Samsung SyncMaster XL20, 20.1-type liquid crystal display with built-in calibration function (https://dc.watch.impress.co.jp/cda/review/2007/05/11/6211.html, accessed on Oct. 19, 2018).

### SUMMARY OF INVENTION

### Technical Problem

However, color unevenness occurs on a display screen of each display device in an environment after production and shipment such as a viewpoint position of a user who views a large screen of a video wall system, a numerical value of white balance, changes in characteristics of display devices over time, and the like.

For this reason, after a video wall system is installed, a color shift between display screens of display devices cannot be sufficiently reduced.

In the case of Non Patent Literature 1, the technique is a technique of uniformly adjusting display colors within display screens of display devices, and thus uniformity of chromaticity between pixels within display screens of individual display devices can be improved.

However, in a video wall system, even when display screens of display devices are aligned after pixels of the display screen of each display device are adjusted to have a uniform display color using a captured image captured using an imaging device and the like, in accordance with a difference in an observation position (a viewing angle) between an imaging device and a user and a difference in spectral characteristics of display screens of display devices, there are cases in which the user recognizes (visually recognizes) presence of color unevenness between display screens of display devices when the user watches a large screen (a composite display screen to be described below) of the video wall system.

In the case of Non Patent Literature 2, a user needs to image display screens of display devices configuring a video wall system using an imaging device and measure color unevenness of each of color components RGB of pixels in the display screens.

For this reason, readjustment of all the display devices configuring the video wall system takes a great deal of time. In addition, even when color unevenness within the display screens of individual display devices is adjusted, in accordance with a difference of the viewing angle described above, there is no compensation enabling sufficient enhancement of a color shift between the display screens of the display devices that is visible from an observation position of a user.

In the case of Patent Literature 3, the technology is a technology of preventing gradation inversion in a display screen of a display device, and there is no effect of inhibition of color unevenness when a white color is displayed on the entire display screen.

As described above, even when each technology of Non Patent Literature 1, Non Patent Literature 2, and Patent Literature 1 is used, it is difficult to sufficiently reduce a color shift between display screens of display devices in a large screen of a video wall system composed of a plurality of the display devices through adjustment using a correction function for color unevenness.

In consideration of the problems described above, an object of the present invention is to provide an image display system such as a video wall system and an image display method capable of easily reducing a color shift between display screens in a large composite display screen composed of the display screens of a plurality of display devices.

### Solution to Problem

According to the present invention, there is provided an image display system that comprises a composite display screen by adjacently arranging display screens of a plurality of display devices, in which each of the display devices includes a color adjusting unit that performs adjustment of colors of each corner area in each of the display screens, and the image display system includes a screen display control unit configured to output environment correction data for adjusting color difference between the corresponding display screens to the color adjusting units.

According to the present invention, there is provided an image display method using an image display system that comprises a composite display screen by adjacently arranging display screens of a plurality of display devices, the image display method including: a color adjusting step of performing adjustment of colors of each corner area in each of the display screens using a color adjusting unit of each of the display devices; and a screen display control step of outputting environment correction data for adjusting color difference between the corresponding display screens to the color adjusting units using a screen display control unit.

### Advantageous Effects of Invention

The present invention can provide an image display system such as a video wall system and an image display method capable of easily reducing a color shift between display screens in a large composite display screen composed of the display screens of a plurality of display devices.

### BRIEF DESCRIPTION OF DRAWINGS

FIG. 1 is a diagram illustrating an example of the configuration of an image display system according to one embodiment of the present invention.

FIG. 2 is a conceptual diagram illustrating corner areas in display screens of display devices illustrated in FIG. 1 and corner area identification information assigned to these corner areas.

FIG. 3 illustrates an example of a selection screen for selecting a corner area displayed on a display screen of a control screen display unit 122.

FIG. 4 is a diagram illustrating an example of a user's selection of a corner area in each of display devices 111, 112, 113, and 114.

FIG. 5 is a conceptual diagram for describing an input screen for inputting environment correction data displayed on a display screen by the control screen display unit 122.

FIG. 6 is a flowchart illustrating an example of an operation of the process of adjusting color difference of a composite display screen of a video wall system.

FIG. 7 is a conceptual diagram illustrating adjustment of color difference of a composite display screen of a video wall system 11.

FIG. 8 is a diagram illustrating an example of the configuration of a display device 111 of the video wall system 11 according to this embodiment.

FIG. 9 is a diagram illustrating an example of gamma characteristics of a liquid crystal panel.

FIG. 10 is a diagram illustrating the process of data interpolation of unevenness correction data D2 using a data interpolating unit 142.

FIG. 11 is a conceptual diagram illustrating a layer of each piece of unevenness correction data D3 at a gradation level of each of 256 gradations, 192 gradations, 128 gradations, and 64 gradations.

FIG. 12 is a diagram illustrating an example of unevenness correction data D3 acquired by superimposing unevenness correction data D2 on unevenness correction data D1 for 255 gradations of a color component G.

FIG. 13 is a conceptual diagram illustrating a display state of a display screen of a display device in which display image data, which has been adjusted by a color adjusting unit 14 according to this embodiment, is displayed.

FIG. 14 is a diagram illustrating another example of the configuration of an input screen for inputting the environment correction data illustrated in FIG. 5.

FIG. 15 is a diagram illustrating a concept of an embodiment of the present invention.

### DESCRIPTION OF EMBODIMENTS

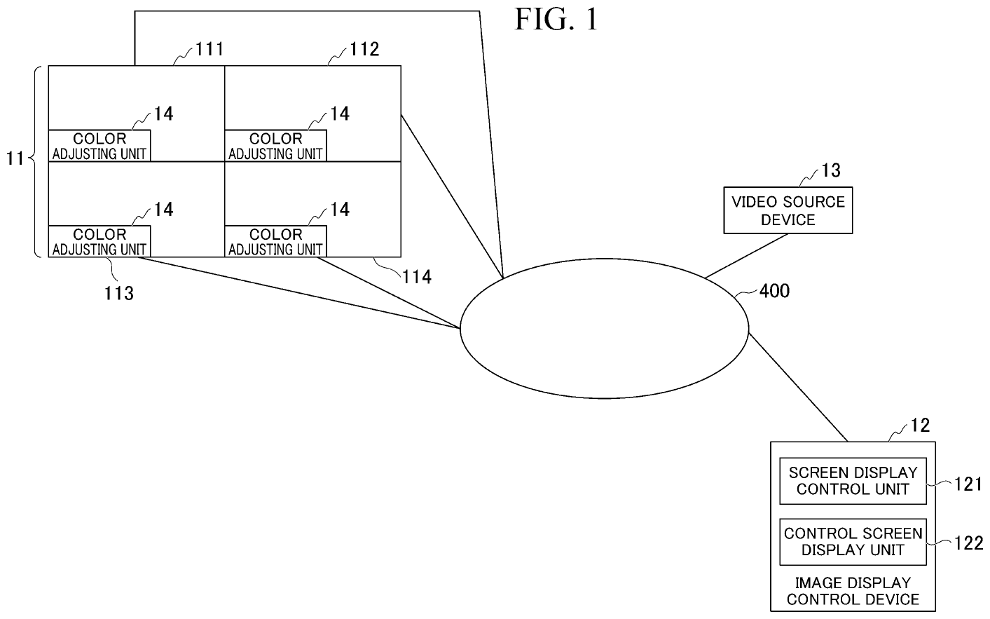

Hereinafter, an image display system according an embodiment of the present invention will be described with reference to the drawings. FIG. 1 is a diagram illustrating an example of the configuration of an image display system according to one embodiment of the present invention. As illustrated in FIG. 1, the image display system 1 includes a video wall system 11, an image display control device 12, and a video source device 13. The video wall system 11, the image display control device 12, and a video source device 13 are connected using information communication lines 400 (a control signal line 401, a video signal line 402, and the like to be described below).

The video wall system 11 is composed of a plurality of display devices and, for example, is composed of display devices 111, 112, 113, and 114 in this embodiment. The display devices 111, 112, 113, and 114 are adjacently arranged at positions at which a side of each image display surface faces a side of another image display surface and is in contact therewith (an arrangement in which image display surfaces are laid in a tile pattern). A composite display screen is formed using the image display surfaces of the display devices arranged to have sides in contact with each other, and this composite display screen becomes a display screen having a large area (a large screen) of a video wall system as a multiple display.

In the display device used in this embodiment, for example, the display screen is composed using a liquid crystal panel. Each of the display devices 111, 112, 113, and 114 includes a color adjusting unit 14. The color adjusting unit 14 has a function of performing adjustment of chromaticity (for example, correction of a gradation level of each of color components red, green, and blue (RGB) of each pixel) for every four corners (corner areas of a rectangular shape) of the display screen of the display device using correction data (details will be described below). For example, this color adjusting unit 14 is a program module that is installed in a control unit composed of a computer of the display device.

The image display control device 12 includes a screen display control unit 121 and a control screen display unit 122. The screen display control unit 121 outputs corner area identification information used for identifying a corner area that is an adjustment target and environment correction data (for example, in this embodiment, a correction coefficient that is an adjustment amount of each of color components RGB of a pixel of a vertex of the corner area) representing an adjustment amount of chromaticity of the corner area represented by the corner area identification information to the color adjusting unit 14 of each of the display devices 111, 112, 113, and 114.

In accordance with this, in the image display system 1, color difference within the composite display screen of the video wall system 11, in other words, color difference in boundary areas between display screens of different adjacent display devices of the display devices 111, 112, 113, and 114, are adjusted, and color difference between display screens of display devices in the composite display screen that are visible to a user are reduced.

In addition, the image display control device 12 may have a configuration in which a program of software (an application) for adjusting color difference of the video wall system 11 is installed in a personal computer or a server, and the functions of the screen display control unit 121 and the control screen display unit 122 are realized as modules in the personal computer.

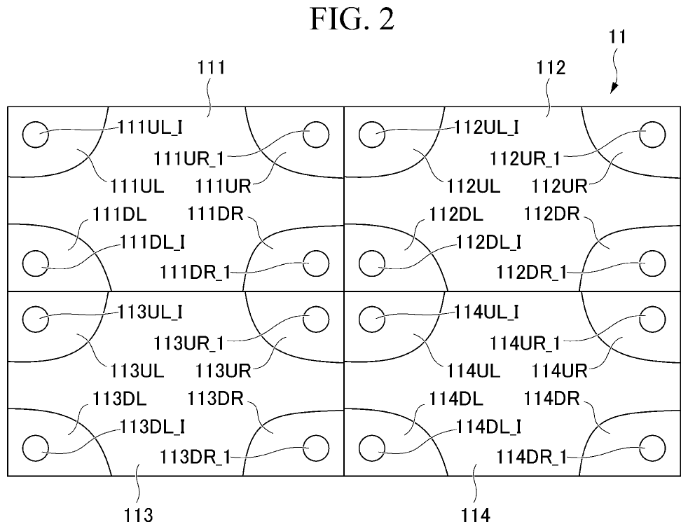

FIG. 2 is a conceptual diagram illustrating corner areas in display screens of display devices illustrated in FIG. 1 and corner area identification information assigned to these corner areas. In FIG. 2, corner area identification information is denoted by points. In a display screen of the display device 111, corner areas 111UL, 111UR, 111DL, and 111DR are disposed, and corner area identification information 111UL_I, 111UR_I, 111DL_I, and 111DR_I is respectively assigned thereto. Similarly, in a display screen of the display device 112, corner areas 112UL, 112UR, 112DL, and 112DR are disposed, and corner area identification information 112UL_I, 112UR_I, 112DL_I, and 112DR_I is respectively assigned thereto.

In addition, in a display screen of the display device 113, corner areas 113UL, 113UR, 113DL, and 113DR are disposed, and corner area identification information 113UL_I, 113UR_I, 113DL_I, and 113DR_I is respectively assigned thereto. In a display screen of the display device 114, corner areas 114UL, 114UR, 114DL, and 114DR are disposed, and corner area identification information 114UL_I, 114UR_I, 114DL_I, and 1124R_I is respectively assigned thereto.

Referring back to FIG. 1, the control screen display unit 122 displays a selection screen for selecting a corner area in which an image representing an arrangement configuration of the display devices described above is displayed on its own display screen.

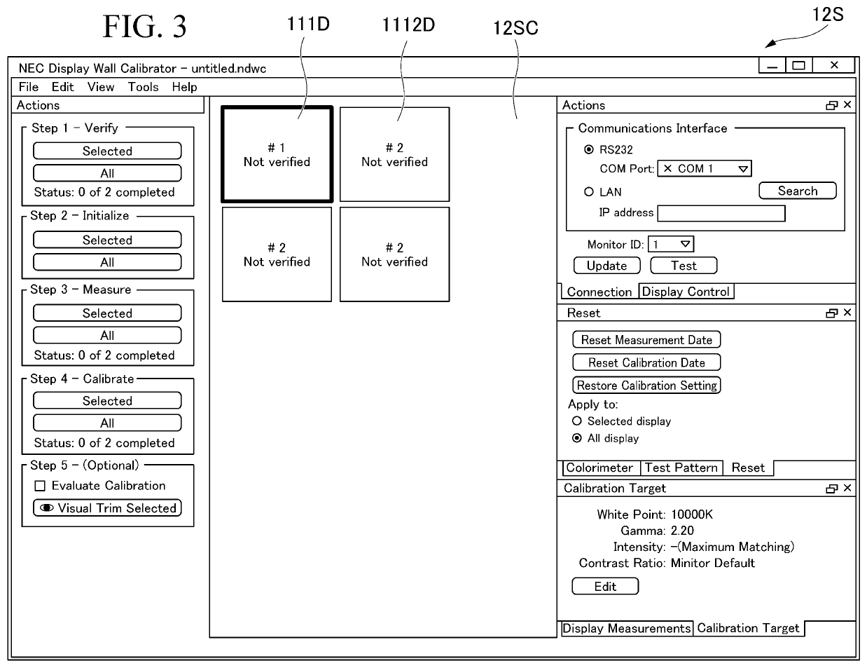

FIG. 3 illustrates an example of a selection screen for selecting a corner area displayed on the display screen of the control screen display unit 122.

The control screen display unit 122 displays display device images 111D, 112D, 113D, and 114D of the display devices 111, 112, 113, and 114 arranged in a selection image area 12SC of the display screen 12S. Then, a user selects a corner area that he or she desires to adjust of a display device image (a corner area that is an adjustment target) in the selection image area 12SC by clicking the corner area using a mouse or the like, whereby corner area identification information of the selected corner area is output from the control screen display unit 122 to the screen display control unit 121.

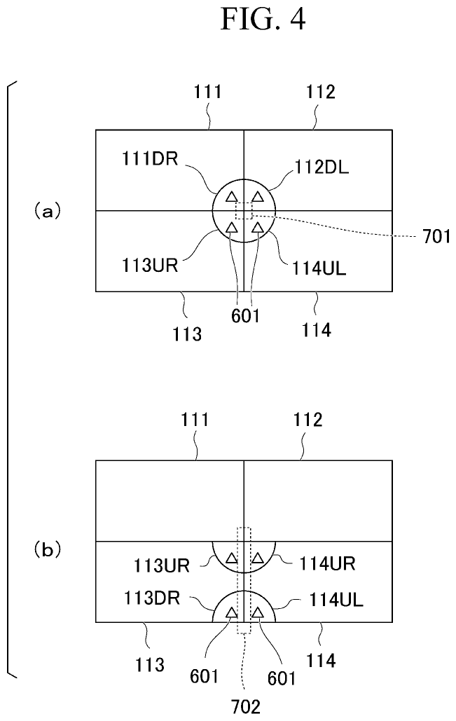

FIG. 4 is a diagram illustrating an example of a user's selection of a corner area in each of the display devices 111, 112, 113, and 114. FIG. 4(a) is a diagram in which the corner areas 111DR, 112DL, 113UR, and 114UL are selected as targets of which chromaticity is to be adjusted due to presence of color difference in a boundary area 801 with which the corner areas 111DR, 112DL, 113UR, and 114UL of the display devices 111, 112, 113, and 114 are in contact. In order to allow a user to easily check corner areas that he or she selected through visual recognition, the control screen display unit 122 displays “A” marks 601 for the corner areas that the user has selected.

FIG. 4(b) is a diagram in which the corner areas 113UR, 113DR, 114UL, and 114DL are selected as targets of which chromaticity is to be adjusted due to presence of color difference in a boundary area 802 with which the corner areas 113UR, 113DR, 114UL, and 114DL of the display devices 113 and 114 are in contact, in other words, a boundary between a right-side part area of the display screen of the display device 113 and a left-side part area of the display screen of the display device 114. Similar to the case of FIG. 4(a), in order to allow a user to visually check corner areas that have been selected, the control screen display unit 122 displays “A” marks 601 for the corner areas that the user has selected.

Referring back to FIG. 1, in a case in which corner areas that are targets for selection are selected, the control screen display unit 122 displays an input screen (an input screen 12CC to be described below) for inputting environment correction data of which chromaticity is to be adjusted.

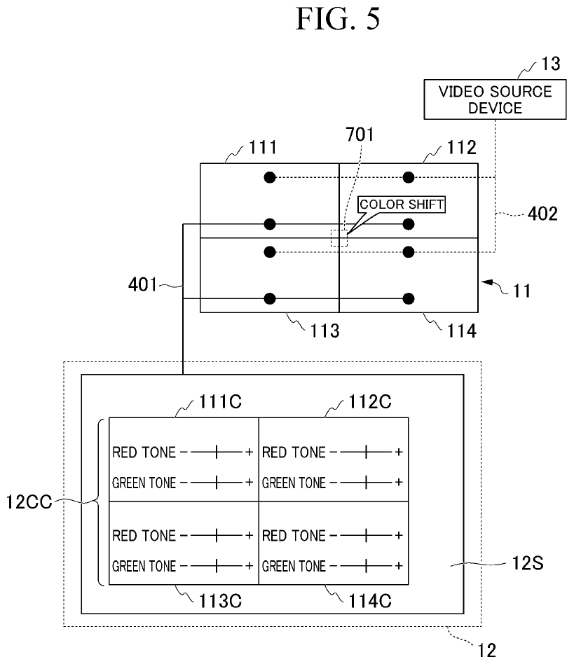

FIG. 5 is a conceptual diagram for describing an input screen for inputting environment correction data displayed on the display screen by the control screen display unit 122.

The video source device 13 divides image data (video data) to be displayed on the entire surface of the composite display screen in correspondence with the number of display devices for each of the display devices 111, 112, 113, and 114 through a video signal line 402 and outputs the divided image data to each display device located at a corresponding position. For example, the video signal line 402 is an HDMI (High-Definition Multimedia Interface; registered trademark), a DisplayPort (DP), or the like.

The image display control device 12 outputs corner area identification information of each corner area that is a target for adjustment of chromaticity and environment correction data to the color adjusting unit 14 of each of the display devices 111, 112, 113, and 114 through a control signal line 401. For example, the control signal line 401 is a local area network (LAN), a Universal Serial Bus (USB), or the like.

The image display control device 12 (the control screen display unit 122) displays a selection image area 12SC for inputting environment correction data for adjusting chromaticity on the display screen 12S. In other words, in a case in which the corner areas illustrated in FIG. 4(a) are selected, the control screen display unit 122 displays an input means for performing adjustment of a red tone (chromaticity a of Color Space Lab) and adjustment of a blue tone (chromaticity b of Color Space Lab) of the corner area 111DR of the display device 111 in a control screen area 111C of an input screen 12CC. Similarly, the control screen display unit 122 displays an input means for performing adjustment of a red tone and adjustment of a blue tone of the corner area 111DL of the display device 112 in a control screen area 112C of the input screen 12CC. In addition, the control screen display unit 122 displays an input means for performing adjustment of a red tone and adjustment of a blue tone of the corner area 111DL of the display device 112 in a control screen area 113C of the input screen 12CC. The control screen display unit 122 displays an input means for performing adjustment of a red tone and adjustment of a blue tone of the corner area 111DL of the display device 112 in a control screen area 114C of the input screen 12CC.

In addition, although a configuration in which environment correction data for performing adjustment using the chromaticity a and the chromaticity b of Color Space Lab is input has been described in this embodiment, a configuration in which environment correction data is input using gradation levels of color components RGB of the RGB color system, numerical values of color components of the CIE color system, chromaticity coordinates of the xyY color system, K (Kelvin) values of color temperatures, or the like may be employed.

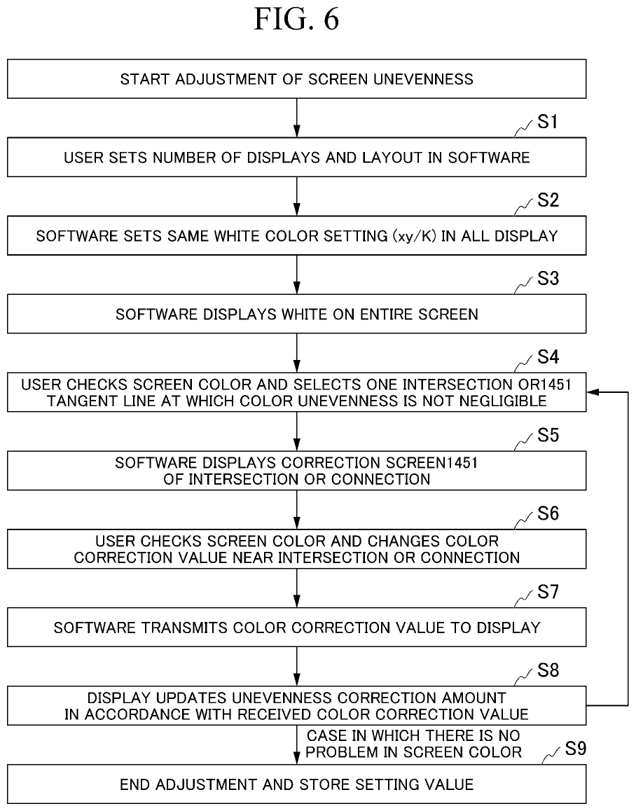

FIG. 6 is a flowchart illustrating an example of an operation of the process of adjusting color difference of a composite display screen of a video wall system. After installing the video wall system 11 at a desired position, a user executes the process of a flowchart illustrated below for reducing color difference between display devices composing a composite display screen by adjusting chromaticity of adjacent corner areas.

Step S1: A user starts the image display control device 12. Then, the user inputs the number of display devices composing the video wall system for which adjustment of color difference is performed and a layout of the arrangement of these display devices (for example, the display devices 111, 112, 113, and 114) to the image display control device 12 using an input means not illustrated in the drawing.

In accordance with this, in the image display control device 12, the control screen display unit 122, as illustrated in FIG. 3, displays display device images 111D, 112D, 113D, and 114D of the display devices 111, 112, 113, and 114 at positions corresponding to the input layout of the arrangement in the selection image area 12SC of the display screen 12S.

Step S2: The screen display control unit 121 outputs a control signal for a screen display for causing the entire surface of the display screen to be in a white color (a control signal for setting a white color) to the color adjusting unit 14 of each of the display devices 111, 112, 113, and 114.

At this time, the screen display control unit 121 measures the display screen of each of the display devices 111, 112, 113, and 114 using a sensor, an imaging device, or the like and performs setting of a white color by outputting a chromaticity control signal (correction data of color components RGB) such that xy values (numerical values of xy chromaticity) or K (Kelvin) values (numerical values of color temperatures of white balance) of the display screens coincide with each other.

In addition, the screen display control unit 121 may be configured to read a control value representing an xy value or a K value of the display screen that is acquired in advance from its own storage unit and set a white color by outputting this control value to the color adjusting unit 14 of each of the display devices 111, 112, 113, and 114 as a control signal.

Step S3: The color adjusting unit 14 of each of the display devices 111, 112, 113, and 114 displays a completely-white image (one example of a predetermined adjustment image) on each display screen in correspondence with a chromaticity control signal supplied from the image display control device 12.

Step S4: The user observes the quality of the composite display screen of the video wall system 11 from a generally-watching position and detects correction target positions at which a color shift is visible within this composite display screen. Then, in each of the display device images 111D, 112D, 113D, and 114D displayed in the selection image area 12SC of the display screen 12S by the control screen display unit 122 (on the layout of the display screen arrangement of the display devices in the display screen 12S), the user selects areas (corner areas) corresponding to the correction target positions at which the color shift has been visible as a boundary area (a boundary area 801) including an intersection illustrated in FIG. 4(a) or a boundary area (a boundary area 802) of contacting sides illustrated in FIG. 4(b) using a pointing device such as a mouse or the like.

Step S5: Then, in a case in which a boundary area (for example, the boundary area 801 illustrated in FIG. 4(a)) of which chromaticity is to be adjusted is selected by a user, the control screen display unit 122 displays an input screen 12CC as a user interface (UI) illustrated in FIG. 5 for inputting environment correction data to the display screen 12S.

In a case in which the user selects the boundary area 801 illustrated in FIG. 4(a), the control screen display unit 122 displays control screen areas 111C, 112C, 113C, 114C on the input screen 12CC for adjusting chromaticity of each of the corner areas 111DR, 112DL, 113UR, 114UR included in the boundary area 801.

On the other hand, in a case in which the user selects the boundary area 802 illustrated in FIG. 4(b), the control screen display unit 122 displays control screen areas in which a display of input means adjusting the chromaticity of each of the corner areas 113UR, 113DR, 114UL, and 114DL included in the boundary area 802 is included on the input screen 12CC.

Step S6: The user observes color difference of correction target positions between display devices on the composite display screen of the video wall system 11 at positions at which the correction target positions have been detected and performs input of an adjustment amount of chromaticity of each of the corner areas 113UR, 113DR, 114UL, and 114DL (input of environment correction data) to input means of each of the control screen areas 111C, 112C, 113C, and 114C such that the color difference are reduced at the correction target positions (for example, the boundary area 801).

Step S7: The control screen display unit 122 outputs the adjustment amount of chromaticity input by the user to each of the control screen areas 111C, 112C, 113C, and 114C to the screen display control unit 121. At this time, in a case in which the user selects the boundary area 801 illustrated in FIG. 4(a), the control screen display unit 122 outputs each adjustment amount of chromaticity (an adjustment amount of the gradation level of each of the color components RGB) for each of pixels included in the corner areas 111DR, 112DL, 113UR, and 114UR included in the boundary area 801 to the screen display control unit 121.

Then, the screen display control unit 121 acquires environment correction data, for example, used for correcting gradation levels of the color components RGB on the basis of adjustment amounts of chromaticity supplied from the control screen display unit 122 and outputs this environment correction data to the corresponding display devices 111, 112, 113, and 114. Here, the screen display control unit 121 converts adjustment amounts of chromaticity for each pixel into correction coefficients of luminance values based on the color components RGB.

At this time, in a case in which a user selects the boundary area 801 illustrated in FIG. 4(a), the environment correction data is environment correction data of each of the color components RGB for each of pixels included in each of the corner areas 111DR, 112DL, 113UR, and 114UR included in the boundary area 801.

Step S8: The color adjusting unit 14 of each of the display devices 111, 112, 113, and 114 performs correction of gradation levels of each of the color components RGB (correction of color unevenness of display to be described below) of pixels of the corner area for which the environment correction data has been supplied on the display screen of each of the display devices for image data of a completely-white image (each of the color components RGB has 255 gradations) that is a predetermined adjustment image displayed in each of the display screens in correspondence with the environment correction data supplied from the image display control device 12.

Then, each of the color adjusting units 14 described above displays a predetermined adjustment image on the display screen of its own display device. In this way, on the composite display screen of the video wall system 11, a predetermined adjustment image corrected using the environment correction data is displayed.

Then, the user observes a color shift between display devices at correction target positions on the composite display screen of the video wall system 11 at the positions at which the correction target positions have been detected.

At this time, when the user does not view a color shift between display screens of display devices (including a case in which a degree of a color shift is an allowed range that is negligible) in a predetermined adjustment image displayed on the composite display screen of the video wall system 11, the user performs input indicating end of adjustment for the corner areas selected by the user on the display screen 12S of the image display control device 12.

In addition, in the embodiment described above, a configuration in which input of the environment correction data (unevenness correction data D2) of a corner area is manually performed by a user observing the composite display screen of the video wall system 11 has been described.

However, a configuration in which, while a user observes the composite display screen of the video wall system 11, environment correction data is acquired not through adjustment of chromaticity of a corner area using manual input of environment correction data but color measurement using a color sensor may be employed. In other words, a configuration in which an observer measures chromaticity values of chromaticity x and y of the periphery of the corner area belonging to a boundary area designated as an adjustment target in each of the display devices 111, 112, 113, and 114 composing the composite display screen of the video wall system 11 and acquires optimal environment correction data by repeating the process of measurement of chromaticity values and adjustment of the environment correction data such that the measured chromaticity values are the same within the designated boundary area may be employed. In accordance with this, the user does not need to observe a difference between color tones of display screens of display devices, and a difference of the color tone in a boundary area of the display screen of each of the display devices 111, 112, 113, and 114 composing the composite display screen of the video wall system 11 can be reduced.

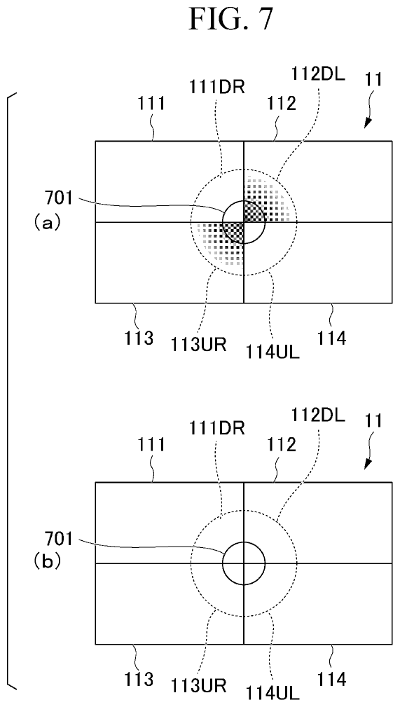

FIG. 7 is a conceptual diagram illustrating adjustment of color difference in the composite display screen of the video wall system 11.

FIG. 7(a) illustrates a state of the composite display screen described above in a case in which a color shift from other corner areas is visible in each of the corner areas 111DR, 112DL, 113UR, and 114UL in the boundary area 801 (FIG. 4(a)) set in the selection image area 12SC.

In addition, FIG. 7(b) illustrates a state of the composite display screen described above in a case in which a color shift from other corner areas is not visible in each of the corner areas 111DR, 112DL, 113UR, and 114UL in the boundary area 801 set in the selection image area 12SC.

Referring back to FIG. 6, in the control screen display unit 122, as illustrated in FIG. 7(b), in a case in which a color shift is not visible in the video wall system 11, the user performs input indicating end of the adjustment.

In accordance with this, the control screen display unit 122 detects the input for ending the process of adjusting a color shift of the composite display screen from the display screen 12S and notifies the screen display control unit 121 of the end of the process for a color shift.

Then, in a case in which the end of the process for a color shift is notified, the control screen display unit 122 causes the process to proceed to Step S9.

On the other hand, in a case in which the user views a color shift between display screens of display devices even after correction (a degree of the color shift exceeds an allowed range with which the user is not concerned) as illustrated in FIG. 7(a) in a predetermined adjustment image displayed on the composite display screen of the video wall system 11, the user performs input for returning to the selection image area 12SC in a predetermined area of the display screen 12S of the image display control device 12.

Then, the control screen display unit 122 detects input for returning to the selection image area 12SC from the display screen 12S and notifies the screen display control unit 121 of the process of adjusting a color shift being continued.

In a case in which the process of a color shift being continued is notified, the control screen display unit 122 causes the process to proceed to Step S4.

Step S9: The color adjusting unit 14 of each of the display devices 111, 112, 113, and 114 internally stores respective environment correction data.

Then, each color adjusting unit 14 corrects a gradation level of each of the color components RGB for each pixel in image data (image data of a part image acquired by dividing the entire image to be displayed on the composite display screen) supplied from the video source device 13 thereto using this environment correction data.

Next, correction for color unevenness using the environment correction data that is performed by the color adjusting unit 14 of each of the display devices 111, 112, 113, and 114 (adjustment of gradation levels of the color components RGB of each pixel) and an adjustment principle thereof will be described.

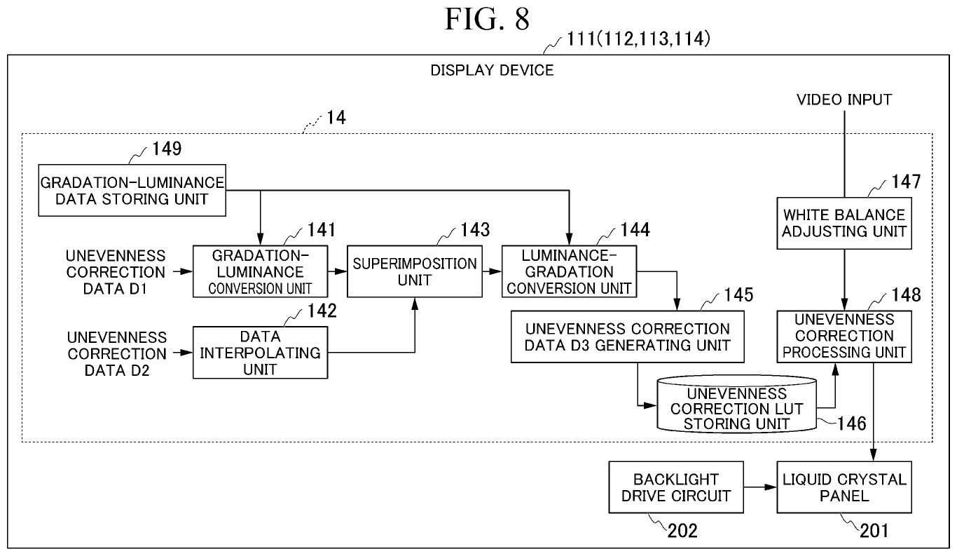

FIG. 8 is a diagram illustrating an example of the configuration of the display device 111 of the video wall system 11 according to this embodiment. In addition, the configuration of each of the other display devices 112, 113, and 114 of the video wall system 11 is similar to that of the display device 111 illustrated in FIG. 8.

In this FIG. 8, the display device 111 includes the color adjusting unit 14 illustrated in FIG. 1, a back-light drive circuit 202, and a liquid crystal panel 201.

The color adjusting unit 14 performs adjustment of an aperture of each pixel (a pixel corresponding to the color components RGB) of the liquid crystal panel 201 without performing correction for the gradation levels of the color components RGB of each pixel of image data supplied from the video source device 13. The back-light drive circuit 202 performs adjustment of radiation luminance of a back-light of the liquid crystal panel 201.

Here, the color adjusting unit 14 includes a gradation-luminance conversion unit 141, a data interpolating unit 142, a superimposition unit 143, a luminance-gradation conversion unit 144, an unevenness correction data D3 generating unit 145, a color unevenness correction lookup table (LUT) storing unit 146, a white balance color adjusting unit 147, a unevenness correction processing unit 148, and a gradation-luminance data storing unit 149.

The gradation-luminance conversion unit 141 reads color unevenness correction data D1 stored in an internal storage unit of the display device 111 in advance and converts gradation levels of pixels of image data corrected using this color unevenness correction data D1 into luminance values by referring to a gradation level-luminance value conversion table that is written and stored in the gradation-luminance data storing unit 149 in advance. The gradation-luminance conversion unit 141 performs this conversion into luminance values for each gradation level of the color components RGB of pixels. The gradation level-luminance value conversion table described above is set in advance in correspondence with each of the color components RGB. In this gradation level-luminance value conversion table, gamma characteristics of the liquid crystal panel 201 measured in advance are written.

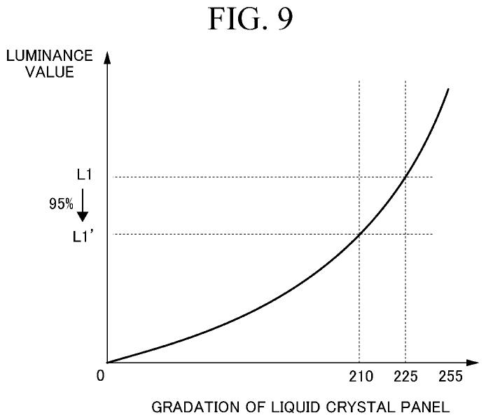

FIG. 9 is a diagram illustrating an example of gamma characteristics of a liquid crystal panel. In FIG. 9, the horizontal axis represents a gradation level (for example, 0 to 255 gradations), and the vertical axis represents a normalized luminance (0 to 1 or 0% to 100%). In other words, the gradation level-luminance value conversion table is a correspondence table between a gradation level and a luminance value (normalized luminance). Here, for example, in a case in which unevenness correction data D1 of which a gradation level has 255 gradations (in the case of white-color display) is a gradation of −30, the gradation-luminance conversion unit 141 converts a gradation of 255-30=225 into a luminance value and sets the luminance value thereof as L1.

The data interpolating unit 142 interpolates the number of points in a horizontal direction H and the number of points in a vertical direction V of color unevenness correction data D2 (a correction coefficient of a luminance value that is environment correction data) supplied from the image display control device 12 to be the same as the number of points in the horizontal direction H and the number of points in the vertical direction V of color unevenness correction data DE In this embodiment, the color unevenness correction data D2 is set in units of color components EGB as a total four points of two points in the horizontal direction H and two points in the vertical direction V (four points of the corner areas 111UL, 111UR, 111DL, and 111DR illustrated in FIG. 2).

Then, the data interpolating unit 142 converts the color unevenness correction data D2 of these four points into the same size as the color unevenness correction data D1 such that it corresponds to the number of points in the horizontal direction H and the number of points in the vertical direction V of the color unevenness correction data DE As one example of this embodiment, the color unevenness correction data D1 is provided in units of color components RGB for each area acquired by dividing a display screen into the shape of a lattice having 40 points in the horizontal direction H and 20 points in the vertical direction V.

For this reason, the data interpolating unit 142 expands the color unevenness correction data D2 of total four points of two points in the horizontal direction H and two points in the vertical direction V into 800 points of 40 points in the horizontal direction H and 20 points in the vertical direction V through a process of data interpolation such as linear interpolation or the like.

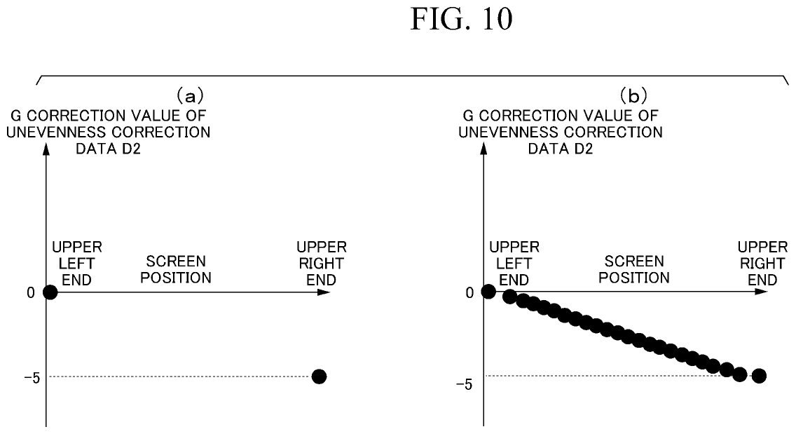

FIG. 10 is a diagram illustrating the process of data interpolation of the unevenness correction data D2 using the data interpolating unit 142. In FIG. 10, as an example, data interpolation of a color component G among color components RGB of the unevenness correction data D2 is illustrated. The process of data interpolation of each of the other color components R and B is similar to that of the color component G illustrated in FIG. 10.

In FIG. 10(a), in the case of the display device 111 illustrated in FIG. 2 as an example, in the unevenness correction data D2, a numerical value input as an adjustment amount (a correction coefficient of a luminance value) of the corner area 111UL is set as an adjustment amount of an upper left end of the display screen, and a numerical value input as an adjustment amount (a correction coefficient of a luminance value) of the corner area 111UR is set as an adjustment amount of an upper left end of the display screen. Here, in FIG. 10(a), the vertical axis represents a correction coefficient, and the horizontal axis represents a position of a pixel on the display screen. In other words, in this embodiment, adjustment amounts given to the corner areas 111UL, 111UR, 111DL, and 111DR are given to pixels present at the vertexes of the corner areas 111UL, 111UR, 111DL, and 111DR. In FIG. 9(a), an adjustment amount for a pixel disposed at the upper left end (the vertex of the corner area 111UL) is “correction coefficient 0 [%]”, and an adjustment amount for a pixel disposed at the upper right end (the vertex of the corner area 111UR) is “correction coefficient 5 [%]”.

FIG. 10(b) illustrates a result of linear interpolation of “correction coefficient 0 [%]” that is a numerical value (a correction coefficient of a luminance value) input as an adjustment amount for the corner area 111UL and “correction coefficient 5 [%]” that is a numerical value input as an adjustment amount for the corner area 111UR in the unevenness correction data D2 in the case of the display device 111 illustrated in FIG. 2 as an example. Here, in FIG. 10(b), similar to FIG. 10(a), the vertical axis represents a correction coefficient, and the horizontal axis represents a position of a pixel on the display screen. FIG. 10(b) illustrates an example in which two points in the horizontal direction H in the color unevenness correction data D2 are linearly interpolated into 20 points in the horizontal direction H that are the same as the number of points in the horizontal direction in the color unevenness correction data D1.

Here, generally, as factors of color unevenness of the display screen, there are a factor depending on the liquid crystal panel and a factor depending on the environment. When a display device is produced, color unevenness at the time of production is adjusted. In a correction for the color unevenness of the liquid crystal panel 201 at the time of production, a process having color unevenness depending on the liquid crystal panel as a correction target is performed. In the case of color unevenness depending on the liquid crystal panel, the color unevenness is disorderly present in a fine uneven shape on the entire surface of the display screen depending on a display color, gradation levels of RGB components, a display position, and the like on the display screen.

On the other hand, in the case of color unevenness depending on the environment, the color unevenness is close to an inclination or a distortion according to a position of a viewing point of a user, a white balance of the display screen, or a change over time (it occurs in accordance with a long-term use) but is not color unevenness with a chromaticity change having a fine uneven shape depending on the liquid crystal panel, and is color unevenness close to an inclination or a distortion in the change of chromaticity having a characteristic of changes at a lower frequency than that of the color unevenness depending on the liquid crystal panel.

In this embodiment, similar to the case of correcting the color unevenness depending on the environment, a color shift of each of the display devices 111, 112, 113, and 114 composing the video wall system 11 is adjusted. In other words, a boundary part between display screens of display devices on the composite display screen of the video wall system 11 is set as a part of a corner area having a wide range, and chromaticity of this corner area is adjusted altogether. In accordance with this, the process of decreasing a degree of color difference at the boundary, at which display screens of a plurality of display devices are connected, of the composite display screen described above, which occur due to a viewing point, a white balance, and the like in the environment in which the video wall system 11 is used to be a degree that the user cannot view (or a range that is allowed by the user) can be performed.

The superimposition unit 143 superimposes (comprises) the unevenness correction data D2 on luminance values of the unevenness correction data D1 supplied from the gradation-luminance conversion unit 141 and causes resultant data to pass through the luminance-gradation conversion unit 144, thereby generating unevenness correction data D3. For example, in a case in which one correction point (output value) of the unevenness correction data D1 in 255 gradations has 225 gradations, the gradation-luminance conversion unit 141 performs conversion using gamma characteristics and outputs a luminance value L1. Here, in a case in which a correction coefficient represented by the unevenness correction data D2 is −5 [%], the superimposition unit 143 outputs (100−5) [%]*L1=95 [%]*L1=L1′ to the luminance-gradation conversion unit 144 (see FIG. 9). Here, 100−5=95 is an environment luminance correction coefficient.

Next, the luminance-gradation conversion unit 144 converts the luminance value L1′ using gamma characteristics and outputs 210 gradations. The 210 gradations acquired by the luminance-gradation conversion unit 144 is a gradation level of the pixel of one correction point of the unevenness correction data D3.

As described above, the superimposition unit 143 performs the process of generating the luminance value L1′ described above using the unevenness correction data D2 that is generated by the data interpolating unit 142 through extension for all the pixels of correction points corresponding to the unevenness correction data D1 in 255 gradations for each of the color components RGB and generates unevenness correction data D3 on the basis of this luminance value L1′.

In addition, in this embodiment, the unevenness correction data D1 is set to unevenness correction data D1 of gradation levels of four levels including not only 255 gradations described above but also 192 gradations, 128 gradations, and 64 gradations in a layer of gradation levels.

For this reason, not only a gradation level of the 255 gradations of the complete white color but also a gradation level of each of 192 gradations, 128 gradations, and 64 gradations, similar to the case of the 255 gradations, the superimposition unit 143 outputs unevenness correction data D1 to the gradation-luminance conversion unit 141. The gradation-luminance conversion unit 141 acquires a luminance value L1 of each of the 192 gradations, the 128 gradations, and the 64 gradations on the basis of the supplied unevenness correction data D1.

Then, the superimposition unit 143 multiplies the luminance value L1 of a gradation level of each of the 192 gradations, the 128 gradations, and the 64 gradations by the environment luminance correction coefficient acquired at 255 gradations using the correction coefficient of the unevenness correction data D2. In accordance with this, the superimposition unit 143 acquires a luminance value L1′ of a gradation level of each of the 192 gradations, the 128 gradations, and the 64 gradations. Then, the superimposition unit 143 outputs the acquired luminance values L1′ to the luminance-gradation conversion unit 144.

The luminance-gradation conversion unit 144 receives the supplied luminance values L1′ of a gradation level of each of 192 gradations, 128 gradations, and 64 gradations as an input and generates unevenness correction data D3 of each gradation level of the 192 gradations, the 128 gradations, and the 64 gradations from an output value.

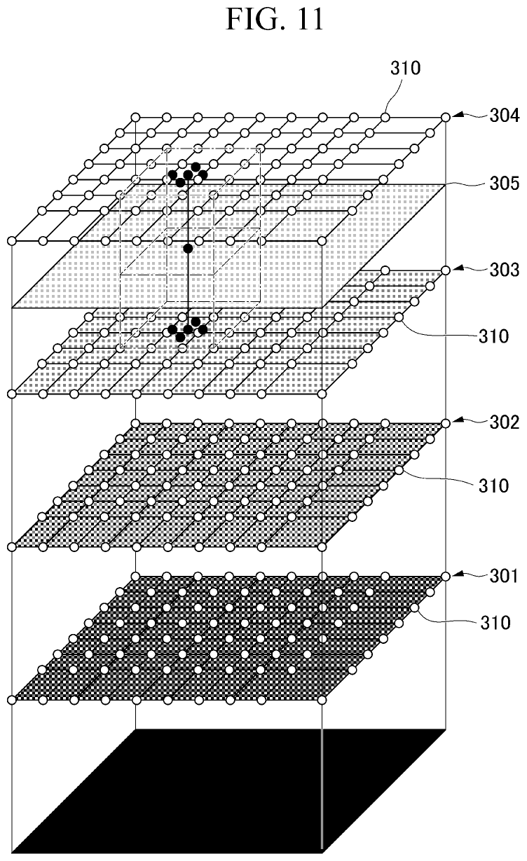

FIG. 11 is a conceptual diagram illustrating a layer of each piece of unevenness correction data D3 at a gradation level of each of 256 gradations, 192 gradations, 128 gradations, and 64 gradations.

Here, in the color unevenness correction LUT storing unit 146, unevenness correction LUTs of unevenness correction data D3 corresponding to a layer 301 of the unevenness correction data D3 having 64 gradations, a layer 302 of the unevenness correction data D3 having 128 gradations, a layer 303 of the unevenness correction data D3 having 192 gradations, and a layer 304 of the unevenness correction data D3 having 255 gradations illustrated in FIG. 11 are set for each of the color components RGB.

In addition, for each of the layers of 256 gradations, 192 gradations, 128 gradations, and 64 gradations, a gradation level as the unevenness correction data D3 is set for each pixel 310 of the display screen of the display device 111.

In addition, in a case in which unevenness correction data D3 of the color components RGB at each pixel of a layer of a gradation level for which the unevenness correction data D3 has not been generated, for example, a layer 305 of 230 gradations is required, the unevenness correction processing unit 148 acquires the unevenness correction data by interpolating the unevenness correction data D3 of an existing layer of gradations. For example, in a case in which unevenness correction data D3 of 230 gradations is required, the unevenness correction processing unit 148 acquires the unevenness correction data by performing linear interpolation of unevenness correction data D3 of pixels corresponding to the 255 gradations that are larger than 230 gradations and the 192 gradations smaller than the 230 gradations, in other words, the 255 gradations and the 196 gradations having 230 gradations interposed therebetween.

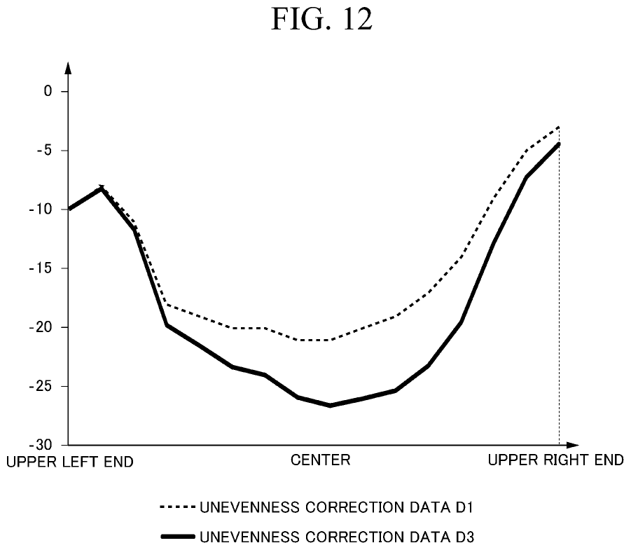

FIG. 12 is a diagram illustrating an example of unevenness correction data D3 acquired by superimposing unevenness correction data D2 on unevenness correction data D1 for 255 gradations of a color component G. In FIG. 12, the vertical axis represents a gradation level of the unevenness correction data D3, and the horizontal axis represents a pixel position of the display screen of the display device 111. A broken line is a curve that represents the unevenness correction data D1, and a solid line is a curve that represents the unevenness correction data D3.

As can be understood from FIG. 12, the unevenness correction data D3 is generated by performing linear interpolation of unevenness correction data D2 from a pixel disposed at the upper left end (for example, in the case of the display device 111, a vertex included in the corner area 111UL of the rectangular display screen) to a pixel disposed at the upper right end (for example, in the case of the display device 111, a vertex included in the corner area 111UR of the rectangular display screen) and superimposing the interpolated unevenness correction data D2 on the unevenness correction data D1 of a corresponding pixel position.

In FIG. 12, it is determined that a degree of reflection (coefficient α) of the unevenness correction data D2 in the unevenness correction data D1 for the unevenness correction data D3 at the upper left end decreases from the unevenness correction data D3 of the pixel disposed at the upper right end.

The luminance-gradation conversion unit 144 acquires unevenness correction data D3 including the amount of correction of the unevenness correction data D2 as environment correction data on the basis of a luminance value L1′ acquired by superimposing the unevenness correction data D2 as a correction coefficient of luminance values on the unevenness correction data D1.

Then, the luminance-gradation conversion unit 144 converts the luminance value L1′ acquired using the unevenness correction data D1 and the unevenness correction data D2 into a numerical value of a gradation level by referring to the gradation level-luminance value conversion table in the gradation-luminance data storing unit 149.

Here, for example, as illustrated in FIG. 12, the luminance-gradation conversion unit 144 converts the luminance value L1′ into 210 gradations as a gradation level.

The unevenness correction data D3 generating unit 145 subtracts 210, which corresponds to the luminance value L1′ acquired using the unevenness correction data D1 and the unevenness correction data D2 from a gradation of 255 (white-color display) of the gradation level of the image data and acquires a gradation of 255−210=45 as unevenness correction data D3 of the layer of the gradation level of 255 gradations.

Here, the luminance-gradation conversion unit 144 writes and stores the color unevenness correction data D3 of each pixel of the display screen acquired in units of pixels for each of the color components RGB in a color unevenness correction LUT corresponding to the layer of 255 gradations of each of the color components RGB in the color unevenness correction LUT storing unit 146.

In addition, together with generating the unevenness correction data D3 of 255 gradations of each of the color components RGB, the unevenness correction data D3 generating unit 145 generates unevenness correction data D3 of each of 192 gradations, 128 gradations, and 64 gradations of each of the color components RGB.

Then, the unevenness correction data D3 generating unit 145 writes and stores corresponding unevenness correction data D3 in color unevenness correction LUTs in units of the color components RGB of 192 gradations, 128 gradations, and 64 gradations in the color unevenness correction LUT storing unit 146.

In order to reproduce a desired white color such as a warm color or a cold color, the white balance color adjusting unit 147 changes a ratio of the color components RGB of each pixel of display image data supplied from the video source device 13 using a setting value of white balance input by the user and outputs the display image data to the unevenness correction processing unit 148.

The unevenness correction processing unit 148 reads a gradation of each of the color components RGB for each pixel of the display image data of which white balance has been adjusted by the white balance color adjusting unit 147 by referring to the color unevenness correction LUT storing unit 146 and reads unevenness correction data D3 by referring to the unevenness correction LUT corresponding to the gradations of the color components RGB of each pixel. Then, the unevenness correction processing unit 148 corrects gradations of the color components RGB for each pixel of the display image data of which white balance has been adjusted using the read unevenness correction data D3 and outputs the corrected display image data to the liquid crystal panel 201 as display image data.

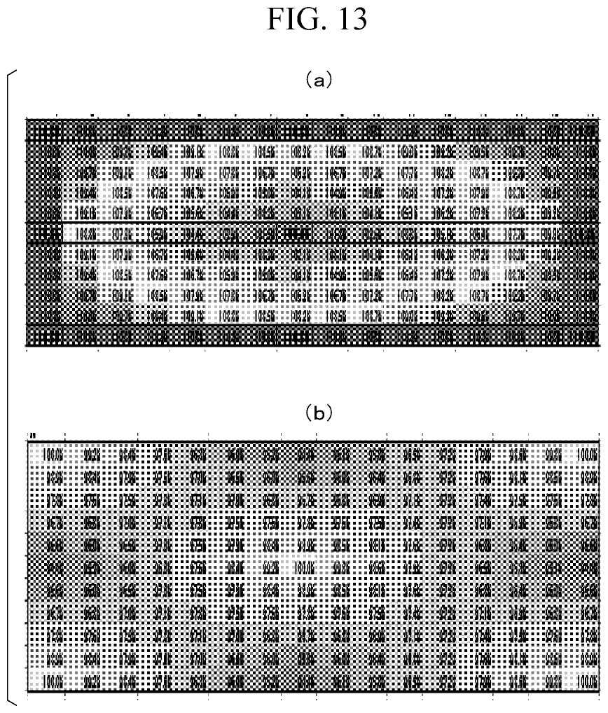

FIG. 13 is a conceptual diagram illustrating a display state of a display screen of a display device in which display image data, which has been adjusted by the color adjusting unit 14 according to this embodiment, is displayed.

FIG. 13(a) illustrates display unevenness of the color component G of the color components RGB of display image data of white display of the entire screen, which has been corrected using the unevenness correction data D1 after setting the gradations of the color components RGB again in accordance with the white balance, on the display screen of the display device. In other words, the gradation level of the color component G of a pixel disposed at the center of the display screen is set as a reference (100%), and ratios of gradation levels of other pixels in the display screen to the center value are illustrated.

As can be understood from FIG. 13(a), the gradation levels have not a characteristic of changing with fine unevenness of color unevenness originated from the liquid crystal panel 201 but a characteristic of changing at a low frequency in which color unevenness according to the setting of white balance has an inclination.

FIG. 13(b) illustrates display unevenness of the color component G of color components RGB after correction of display image data using the color unevenness correction data D3. As can be understood from FIG. 13(b), color unevenness according to use environments (for example, a user's setting of white balance) and the like is corrected.

In this embodiment, by using the function of correcting color unevenness according to use environments described above, color difference at the boundary between display screens of display devices adjacent to each other on the composite display screen of the video wall system 11 are adjusted.

By employing the configuration described above, according to this embodiment, on the composite display screen of the video wall system 11, color difference, which have occurred in accordance with use environments, visible at boundary parts between display screens of display devices adjacent to each other can be reduced using the function of correcting color unevenness provided in the display devices.

In other words, according to this embodiment, color difference between display screens of display devices that have occurred in accordance with environments of a place at which the system has been installed by the user or use environments such as a setting of white balance and the like can be reduced by the user who has installed and observes the system, and thus, unlike a conventional case, installation of a facility of a dark room used for the adjustment, addition of an imaging device, and a correction circuit, or the like is not necessary, and color difference that are visible can be adjusted in a simple manner such that it can be accepted by the user in any environment.

In addition, according to this embodiment, since the unevenness correction data D1 used for correcting the color unevenness of the liquid crystal panel 201 at the time of production is acquired in advance, the color unevenness correction data D3 is generated by observing the composite screen of the video wall system 11 on which a white color is displayed on the entire surface and superimposing the color unevenness correction data D2 input by the user for correcting color difference between display screens of the display devices in correspondence with the user environments on the unevenness correction data D1 described above. Thus, the quality of the image in which unevenness is reduced more than that of the adjustment of a conventional video wall system can be provided.

In addition, according to this embodiment, for the unevenness correction data D3 input by the user, only an adjustment amount of a gradation level for adjusting each of the color components RGB of a pixel disposed at the end part of each corner area with which the display screens of display devices are in contact is input, and thus, the unevenness correction data D3 can be generated by the user simply and manually.

FIG. 14 is a diagram illustrating another example of the configuration of an input screen (an input screen 12CC) for inputting the environment correction data (the unevenness correction data D2) illustrated in FIG. 5. On the input screen illustrated in FIG. 5, the image display control device 12 inputs environment correction data through adjustment of chromaticity and converts the internally-input chromaticity into a gradation level of each of the color components RGB, and outputs the environment correction data converted into the gradation level to the color adjusting unit 14 of each of the display devices 111, 112, 113, and 114.

In FIG. 14, for example, input fields 501 and adjustment bars 502 of the color components RGB of each of the corner areas 111DR (Lower Right), 112DL (Lower Left), 113UR (Upper Right), and 114UR (Upper Left) illustrated in FIG. 4(a) are illustrated.

In the configuration illustrated in FIG. 14, input of environment correction data as gradation levels of the color components RGB is directly performed.

In accordance with this, the image display control device 12 outputs the environment correction data input to the input screen in the display screen to the display devices 111, 112, 113, and 113 in the input state.

In addition, in this embodiment, although each of the display devices 111, 112, 113, and 113 has been described to have the function of correcting color unevenness in each corner area, a configuration in which not only corner areas but also a plurality of areas between the corner areas are corrected may be employed. In other words, as another embodiment, a configuration in which not only four corner areas but also one or two or more areas between the corner areas for which correction is performed are included may be employed. Alternatively, by dividing each of display screens of the display devices 111, 112, 113, and 113 into a plurality of division screens (for example, the display screen is divided into 9 division screens through 3×3 division for which correction is performed, or the display screen is divided into 25 division screens through 5×5 division for which correction is performed), each division screen acquired through division may be set as an area for which correction is performed. In addition, depending on the configuration of the video wall, a display device that does not perform unevenness correction of a corner area that is not connected to other display devices may be used.

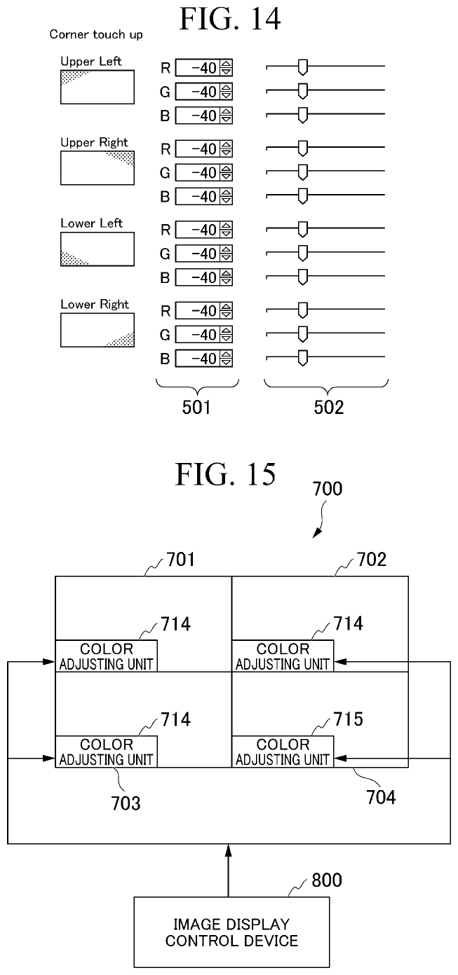

FIG. 15 is a diagram illustrating a concept of an embodiment of the present invention. An image display system 700 includes a plurality of display devices that compose a multiple display, for example, display devices 701, 702, 703, and 704. In addition, each of the display devices 701, 702, 703, and 704 includes a color adjusting unit 714 that has a function of correcting color unevenness of each corner area of a vertex part of a display screen having a rectangular shape inside.

An image display control device 800 of the image display system 700 observes a composite display screen of the multiple display and, in a case in which environment correction data for adjusting color difference that are visible between the display screens of the display devices is input by a user, outputs corresponding environment correction data to each of the color adjusting units 714.

Then, each of the color adjusting units 714 adjusts color difference of the corner area in correspondence with the input environment correction data.

In addition, in the video wall system 11 illustrated in FIG. 1, although the image display control device 12 is installed as an independent computer system, the image display control device 12 may be configured to be included in any one of the display devices 111, 112, 113, and 114. Then, control for realizing a control function for adjusting color difference at the boundary between the display screens of the display devices composing the composite display screen of the video wall system 11 may be performed. A “computer system” described here includes an OS and hardware such as peripherals.

As above, while the embodiment of the present invention has been described in detail with reference to the drawings, a specific configuration is not limited to this embodiment, and a design and the like not departing from the concept of the present invention are included therein.

### INDUSTRIAL APPLICABILITY

The image display system and the image display method described above allow a user to easily perform an operation of reducing color difference, which are visible, at the boundary between display screens of display devices in a multiple-display device such as a video wall system composed of a plurality of display devices through adjustment and are effective to realize reduction of a load on the user.

### REFERENCE SIGNS LIST

1 image display system
11 video wall system
12 image display control device
12CC input screen
12S display screen
12SC selection image area
13 video source device
14 color adjusting unit
111, 112, 113, 114 display device
111C, 112C, 113C, 114C control screen area
111D, 112D, 113D, 114D display device image
111UL, 111UR, 111DL, 111DR, 112UL, 112UR, 112DL, 112DR, 113UL,
113UR, 113DL, 113DR, 114UL, 114UR, 114DL, 114DR corner areas
121 screen display control unit
122 control screen display unit
141 gradation-luminance conversion unit
142 data interpolating unit
143 superimposition unit
144 luminance-gradation conversion unit
145 unevenness correction data D3 generating unit
146 unevenness correction LUT storing unit
147 white balance color adjusting unit
148 unevenness correction processing unit
149 gradation-luminance data storing unit
201 liquid crystal panel
202 back-light drive circuit
400 information communication line
401 control signal line
402 video signal line
601 mark
701, 702 boundary area

What is claimed is:

1. An image display system comprising:
a plurality of display devices comprising:
a plurality of display screens which are adjacently arranged to form a composite display screen; and
a plurality of color adjusting units configured to perform adjustments of colors of each corner area in the plurality of display screens respectively, and
a screen display control unit configured to output, to each of the color adjusting units, environment correction data for adjusting color difference between the display screens.

2. The image display system according to claim 1, further comprising:
a control screen display unit configured to display a control image representing an arrangement configuration of the display screens of the display devices.

3. The image display system according to claim 2, wherein the control screen display unit outputs corner area position information representing positions of corner areas selected for adjusting colors among the corner areas of the display devices displayed in the control image to the screen display control unit.

4. The image display system according to claim 3, wherein the selected corner areas are corner areas facing each other in the display screens of the display devices that are adjacent to each other.

5. The image display system according to claim 2, wherein the control screen display unit displays a color correction amount input means for inputting the environment correction data for adjusting the colors of the selected corner areas as the control image.

6. The image display system according to claim 1, wherein, when the environment correction data is acquired, the screen display control unit causes the color adjusting units of all the arranged display devices to display a predetermined adjustment image after correction of display unevenness based on display characteristics of the display devices within the display screens on the display screens forming the composite display screen.

7. An image display method for display images on an image display system comprising: a plurality of display devices having a plurality of display screens which are adjacently arranged to form a composite display screen, the image display method comprising:
performing, by a color adjusting unit of each of the display devices, adjustment of colors of each corner area in each of the display screens; and
outputting, by a screen display control unit, to the color adjusting units, environment correction data for adjusting color difference between the corresponding display screens.
